(19) United States
(12) Patent Application Publication
(10) Pub. No.: US 2026/0060161 A1
(43) Pub. Date: Mar. 5, 2026

(54) A RECONFIGURABLE TRACTOR ATTACHMENT KIT

(71) Applicant: 14324722 CANADA INC., CHATSWORTH (CA)

(72) Inventor: MATTHEW JOHN MCLEOD, CHATSWORTH (CA)

(21) Appl. No.: 19/108,253

(22) PCT Filed: Dec. 11, 2023
(86) PCT No.: PCT/CA2023/051634

§ 371 Date: Mar. 3, 2025

Related U.S. Application Data
(60) Provisional application No. 63/431,981, filed on Dec. 12, 2022.
(60) Provisional application No. 63/441,028, filed on Jan. 25, 2023.

(51) Int. Cl. A01B 59/00; A01B 59/06

(52) U.S. Cl. CPC A01B 59/002; A01B 59/066

(57) ABSTRACT

A reconfigurable tractor attachment kit for use with a tractor, having a tractor attachment element releasably attachable to the tractor. A pair of side plates are releasably attachable to the tractor attachment element on opposed sides thereof. A cross member is releasably attachable between the pair of side plates and spaced from the tractor attachment element. The reconfigurable tractor attachment kit is attachable to the tractor when assembled into an attachment.

### BACKGROUND

The present disclosure relates to tractor attachments and, in particular, reconfigurable tractor attachments.

Tractor attachments of various types have been in use for over fifty years generally for a single purpose. Various attachments are commonly used depending on the location and the season. For example, attachments are used to work in gravel, dirt, snow, and stone. Generally, the user will purchase an attachment to perform work and store the attachment until that use is again required. Accordingly, some attachments are used only for a short period of time each year. Some attachments are typically used in the spring like a tine rake or an aerator and may not be used again for the rest of the season. Whilst in the winter only the snow plow may be used. Accordingly, a lot of space may be used to store attachments when not in use.

Each attachment will commonly use either a hitch or a front loader connection. For a user to get the full functionality from their tractor the user would need multiple attachments. Multiple single use attachments may be very expensive and require a lot of space to store. Though attachments have achieved considerable popularity and commercial success, there has been a continuing need for improvement.

Accordingly, it would be advantageous to provide attachments that may have multiple uses. As well, it would be advantageous to provide attachments that may be attached to different makes of tractors. This would be particularly advantageous to users that have a fleet of different brands of tractors or manufacturers that can produce an attachment that may be used with different brands of tractors. As well, it would be advantageous to provide attachments that may be used simultaneously.

### SUMMARY

A reconfigurable tractor attachment kit for use with a tractor. The kit includes at least a tractor attachment element, a pair of side plates, and a cross member. The hitch frame is releasably attachable to the tractor. The pair of side plates are releasably attachable to the hitch frame on opposed sides thereof. The cross member is releasably attachable between the pair of side plates and spaced from the hitch frame. When assembled into an attachment the reconfigurable tractor attachment kit is attachable to the tractor. The kit may also include a plurality of additional elements.

The tractor attachment element may be a hitch frame. The hitch frame may include a top bar, a bottom bar spaced from the top bar and a pair of side supports attached on opposed sides of the top and bottom bar. Each of a plurality of cultivator tines may be releasably attachable to the bottom bar. Each cultivator tine may be attachable at different heights and is attachable in an inverted position. The hitch frame may further include a ballast bracket configured to receive at least one ballast weight. The hitch frame may be a three point hitch.

Each of the pair of side plates may have a front edge, a back edge, a bottom edge and a top edge and each side plate has a plurality of holes formed therein proximate to the front edge configured to provide different locations for releasably attaching the hitch frame thereto whereby the hitch frame can be configured at different heights and a plurality of holes formed proximate to the back edge and bottom edge for releasably attaching the cross member in different positions. A pair of skids may be releasably attachable to the bottom edge of each side plate respectively.

The cross member may be a roller rotatably attachable between the pair of side plates. The cross member may be an aerator assembly rotatably attachable between the pair of side plates. The cross member may be a first cutting edge cross member attachable between the pair of side plates. A second cutting edge cross member may be releasably attachable between the pair of side plates and spaced from the first cutting edge cross member. The first and second cutting edge cross members may be attachable at a plurality of different attach angles. The cross member may be a tine rake assembly attachable between the pair of side plates.

The tractor has a front loader and the kit may further include a front loader adaptor attachable to the tine rake assembly whereby the attached front loader adaptor and tine rake assembly are attachable to the front loader of the tractor.

The tractor attachment element may be a front loader adaptor attachable between the pair of side plates.

The tractor has a front loader and the front loader adaptor may be attachable to the front loader of the tractor. A cutting edge cross member may be releasably attachable to the front loader adaptor.

A tractor attachment for use with a tractor having a front loader includes a tine rake assembly releasably attachable to the front loader, the tine rake assembly having a front loader adaptor, a plurality of tines extending downwardly from the front loader adaptor, and at least a pair of spaced apart wheels. The tine rake assembly may have a plurality of different front loader attachments such that the tractor attachment is attachable to tractors made by different manufacturers. A second tractor attachment may be attachable to the back of the tractor thereby configuring the tractor to do more than one function. The second tractor attachment may be an aerator assembly thereby configuring the tractor to function as a tine rake and aerator concurrently. A lawn mower attachment may be attached under the tractor thereby configuring the tractor to perform three functions concurrently.

A tractor attachment for use with a tractor includes a hitch frame releasably attachable to the back of the tractor; a pair of side plates attached to the hitch frame on opposed sides thereof; a first and second spaced apart cutting edge rotatably attached between the pair of side plates and spaced from the hitch frame whereby the angle of the cutting edge is adjustable; and wherein when assembled the tractor attachment is dragable behind the tractor.

A tractor attachment for use with a tractor having a front loader includes a front loader adaptor; a John Deere™ type mount operably attached to the front loader adaptor; and a skid steer type mount operably attached to the front loader adaptor. The John Deere™ type mount may include a pair of spaced apart hooks extending from a top edge of the front loader adaptor and a pair of spaced apart locking pins spaced downwardly from the top edge of the front loader adaptor. The skid steer type mount may include an elongate lip extending downwardly along a top of the front loader adaptor and a plurality of holes formed in a bottom lip of the front loader adaptor. The tractor attachment may be one of a front loader box plow, a front loader straight plow, and a front loader tine rake.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1 is a perspective view of a disassembled reconfigurable tractor attachment kit showing a plurality of potential parts;

FIG. 2 is a perspective view of the three point hitch frame of the reconfigurable tractor attachment kit of FIG. 1;

FIG. 3 is a perspective view of the reconfigurable tractor attachment kit of FIG. 1 configured as a ballast frame;

FIG. 4A is an enlarged side view of the quick attach bearing mount of FIG. 4B;

FIG. 4B is an enlarged side view of the side plate similar to that shown in FIG. 1, but also showing a quick attach bearing mount attached thereto;

FIG. 5 is an enlarged side view of the side plate of the reconfigurable tractor attachment kit of FIG. 1;

FIG. 6 is an enlarged perspective view of the side plate of FIG. 5, showing a pair of cutting edge cross members attached thereto;

FIG. 7 is an enlarged perspective view of the front loader adaptor shown in FIG. 1;

FIG. 8 is a perspective view of the reconfigurable tractor attachment kit of FIG. 1 configured as a land plane attachment;

FIG. 9 is a perspective view of the reconfigurable tractor attachment kit of FIG. 1 configured as box blade attachment;

FIG. 10 is a perspective view of the reconfigurable tractor attachment kit of FIG. 1 configured as tine rake attachment;

FIG. 11 is a perspective view of the reconfigurable tractor attachment kit of FIG. 1 configured as an aerator attachment;

FIG. 12 is a perspective view of the reconfigurable tractor attachment kit of FIG. 1 configured as a roller attachment;

FIG. 13 is a perspective view of the reconfigurable tractor attachment kit of FIG. 1 configured as a front loader box plow attachment;

FIG. 14 is a perspective view of the reconfigurable tractor attachment kit of FIG. 1 configured as a cultivator attachment;

FIG. 15 is a perspective view of the reconfigurable tractor attachment kit of FIG. 1 configured as front loader straight plow attachment;

FIG. 16 is a perspective view of the reconfigurable tractor attachment kit of FIG. 1 configured as front loader tine rake attachment;

FIG. 17 is an enlarged perspective view of the side plate of FIG. 5 but also showing the front loader adaptor attached thereto;

FIG. 18 is an enlarged perspective view of the side plate of FIG. 5 but also showing the front loader adaptor and a cutting edge cross member attached thereto;

FIG. 19 is a blown apart perspective view of front loader tine rake attachment configuration of FIG. 16;

FIG. 20 is a perspective view of the front loader tine rake attachment configuration attached to the front loader of a tractor and the aerator configuration attached to the back of the tractor; and

FIG. 21 is another side view of the side plate of the reconfigurable tractor attachment kit of FIG. 1, showing the assisted-alignment features of the side plate.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein the “operably connected” or “operably attached” means that the two elements are connected or attached either directly or indirectly. Accordingly, the items need not be directly connected or attached but may have other items connected or attached therebetween.

One of the challenges with tractors and tractor attachments is that each attachment is typically a single purpose item. This leads to considerable cost to have multiple attachments providing a wide range of different uses. Also, multiple attachments can take up considerable storage space. Accordingly, it would be advantageous to provide a reconfigurable attachment that addresses these issues.

The following examples are presented to enable those skilled in the art to understand and to practice embodiments of the present disclosure. They should not be considered as a limitation on the scope of the disclosure, but merely as being illustrative and representative thereof.

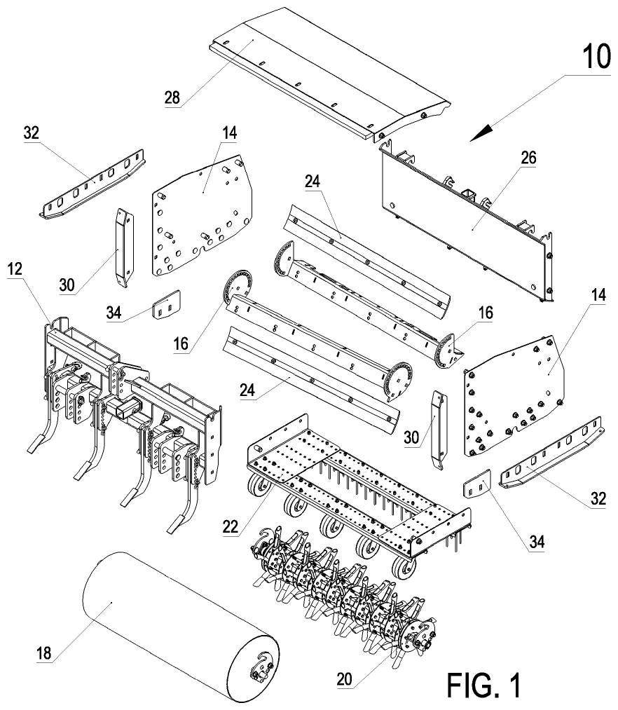

Referring to FIG. 1, a disassembled reconfigurable tractor attachment kit showing a plurality of potential parts is shown generally at 10. The kit shown herein includes a plurality of potential parts and it will be clear to those skilled in the art that a kit could include all or a portion of the parts. As well some part could be sold separately.

Tractor attachment kit 10 includes a tractor attachment element specifically a hitch frame 12, a pair of side plates 14, and a cross member. The cross member may be one or more cutting edge cross members 16, a roller 18, an aerator assembly 20, a tine rake assembly 22, a front loader adaptor 26 or a back drag mouldboard 28.

Cutting edge cross members 16 may include a detachable cutting edge blade 24.

The kit may also include a tractor attachment element specifically a front loader adaptor 26, a back drag mouldboard 28, a pair of back drag skid shoes 30, a pair of skid shoes 32, and a pair of wear plates 34.

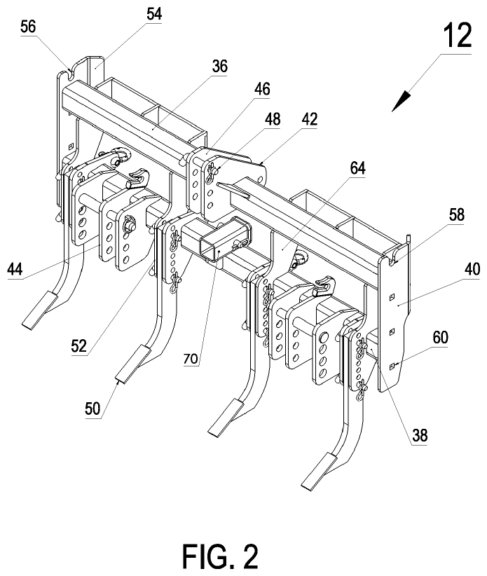

The hitch frame 12 shown herein is a three point hitch frame as best seen in FIG. 2. Hitch frame 12 includes a top bar 36, a bottom bar 38 spaced from the top bar 36 and a pair of side supports 40 attached on opposed sides of the top bar 36 and bottom bar 38. The three point hitch includes a top link mount 42 and a pair of lower link mounts 44. The top link mount 42 and lower link mounts 44 are adjustable with multiple connection points so that the height and pitch of the hitch frame 12 are adjustable. The mounts have a plurality of holes 46 for receiving cotter pins 48 to provide adjustable attachment locations.

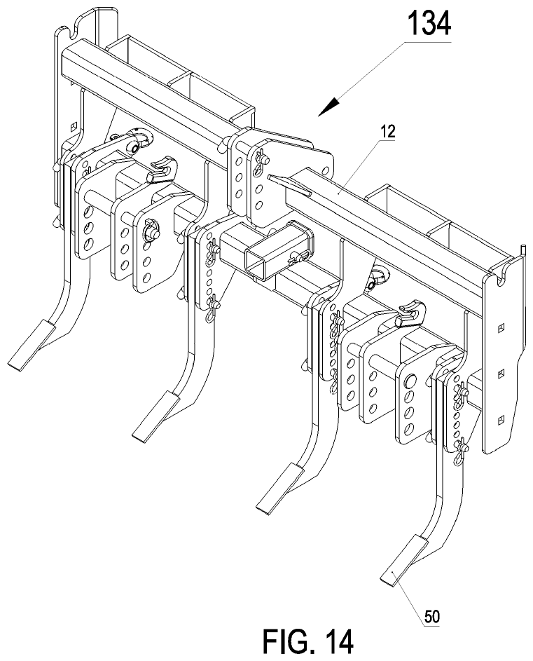

The hitch frame 12 may include a plurality of cultivator tines 50 adjustably and removably attached to the frame 12 at tine mounts 52. The cultivator tines 50 may also be called scarifier tines or shank tines. The cultivator tines 50 may be positioned with the tines positioned downwardly at different heights to create furrows at different depths. Alternatively, they may be positioned upwardly to be out of the way such that tines 50 may be used to add weight to the attachment. However, typically when used as a cultivator attachment as shown in FIG. 14 the plurality of cultivator tines 50 are all at the same height.

The side supports 40 may function as guide plates with the inner longitudinal edge 54 bent inwardly to assist in guiding the three point hitch frame 12 in-between side plates 14. This aids to support the spread of the side plates 14 while assembling and disassembling thereby using the tractor to provide support and aid in the assembly and disassembling process.

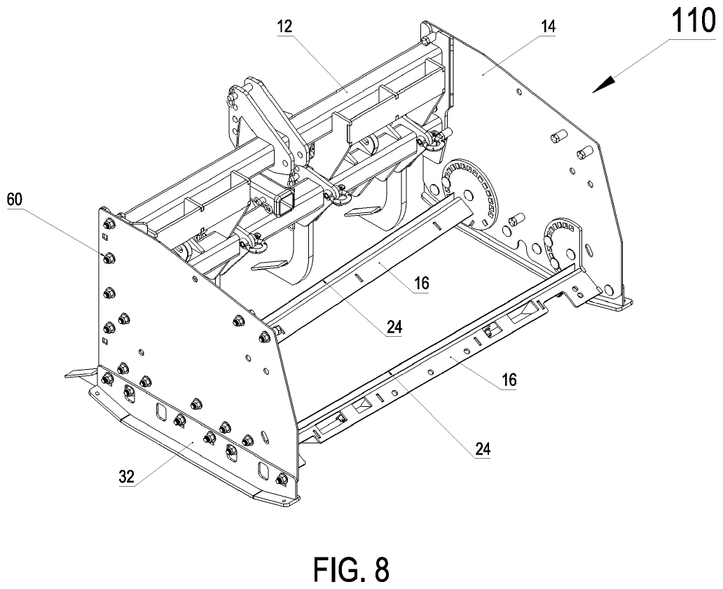

The three point hitch frame 12 may include a groove 56 formed in the top of each side support 40 configured to receive a locator pin 58. In use, the locator pin 58 extends inwardly from side plate 14 or another component being attached to the three point hitch frame 12. This may be seen in a number of the drawings of the different assembled tractor attachments, for example FIG. 8. A plurality of bolts 60 may be used to attach the three point hitch frame 12 to a side plate 14 or another component.

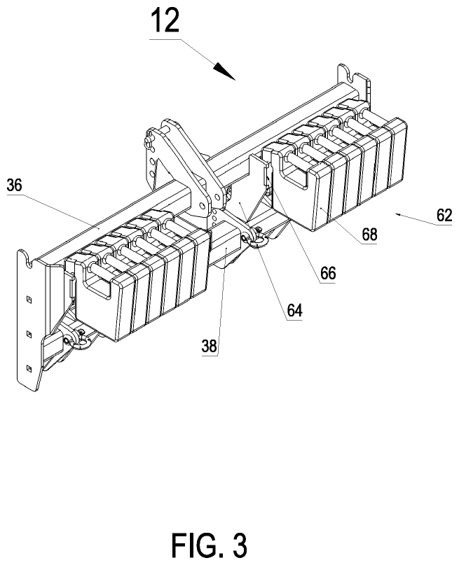

The three point hitch frame 12 may also include a ballast bracket assembly 62 including a pair of spaced apart side brackets 64 and a ballast bar 66 as best seen in FIG. 3. The side brackets are attached to the top bar 36 and bottom bar 38 of three point hitch frame 12. The ballast bar 66 is spaced from the top bar 36. One or more ballast weight 68 may be hung onto the ballast bar 66. The ballast weights 68 shown herein are suitcase ballast weights and are shown by way of example only.

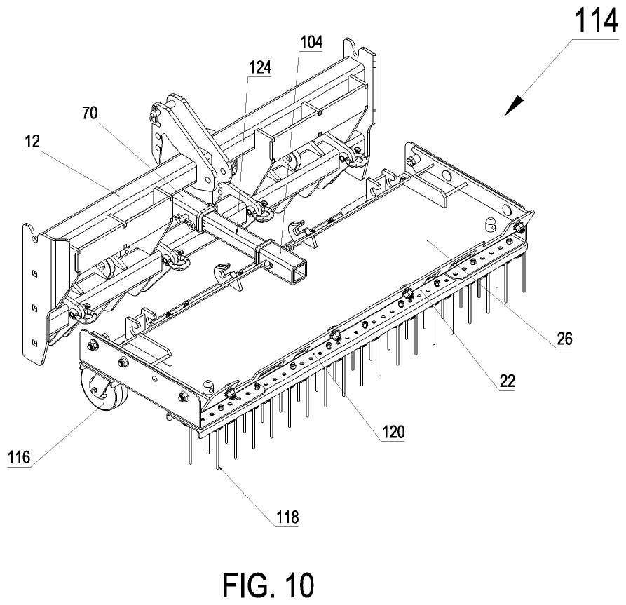

The three point hitch frame 12 may also be equipped with a three point hitch class receiver 70 centred thereon. This allows the user to attach other devices to the three point hitch frame 12 such as a three point hitch tine rake assembly 114, as best seen in FIG. 10, or a number of other attachments that would be compatible with such a receiver, such as a trailer that may also be attachable to a car or a truck.

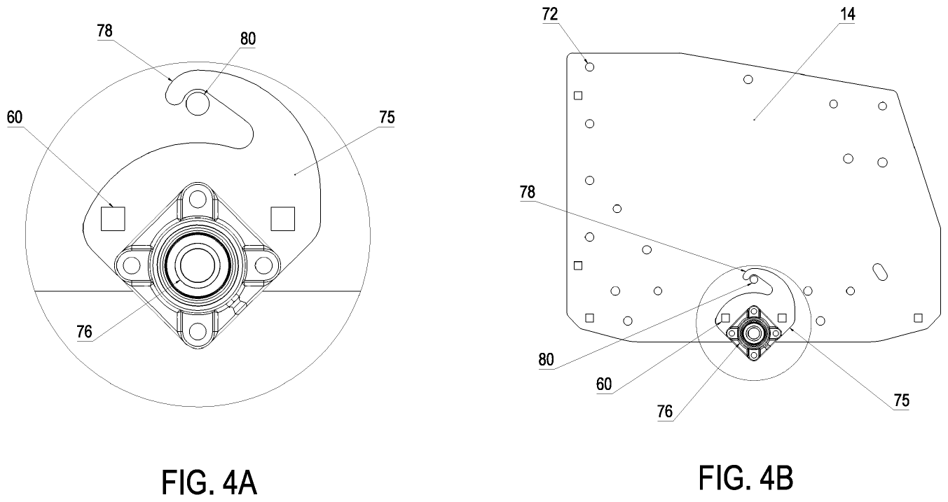

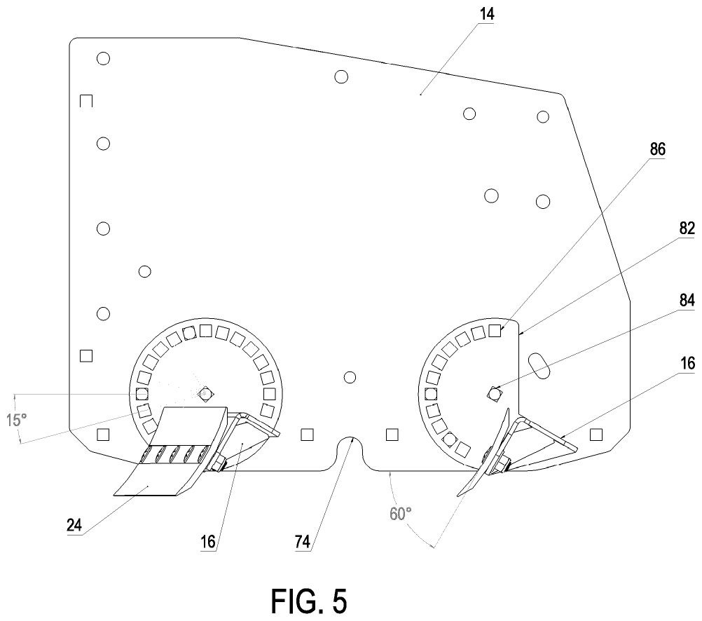

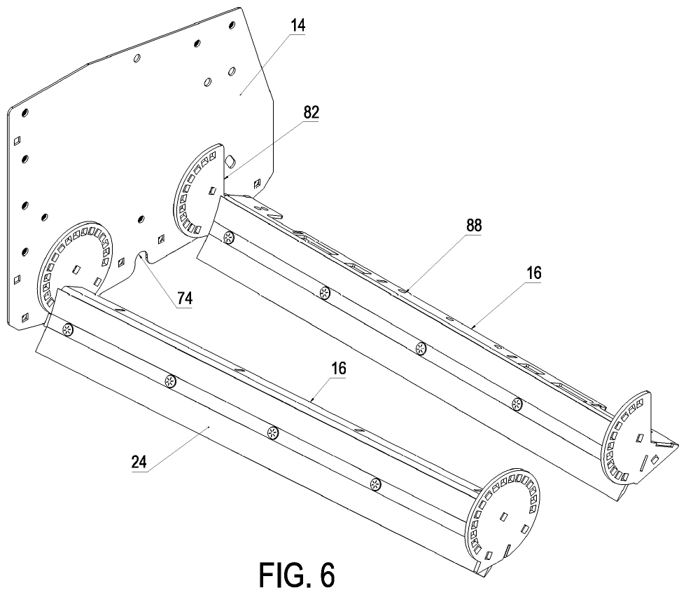

Side plates 14 have a plurality of holes 72 around the periphery thereof as best seen in FIGS. 4B and 5. The holes 72 are positioned to facilitate the attachment of various components to the side plates 14. Each side plate 14 has a notch 74 along the one side thereof as best seen in FIGS. 5 and 6. In the orientation shown in FIGS. 5 and 6 the notch 74 is along the bottom edge of the side plate 14. In use, when the kit 10 is being configured to include a component with a bearing mount assembly 75 having a shaft 76, the shaft 76 would be aligned with the notch 74 as best seen in FIG. 4B. The bearing mount assembly 75 may include a hook portion 78 which is configured to be hooked onto a bushing 80 that extends outwardly from the side plate 14. The bushing 80 is attachable to a hole 72 above the notch 74. The hook portion 78 allows the bearing mount assembly 75 to self-align when lifted. The bearing mount assembly 75 has one or more fastener apertures for receiving bolts 60 which are positioned to align with one or more holes 72 on the side plates 14 when the bearing mount assembly 75 is hanging from the bushing 80 by the hook portion 78. In this way, the hook portion 78 facilitates fastening the bearing mount assembly 75 to the side plate 14. This aids the users in connecting or disconnecting the bearing mount assembly 75 by eliminating the need for the user to precisely position the bearing mount assembly 75 to align with the holes 72. The bearing mount assembly is removably connected to side plate 14 with bolts 60.

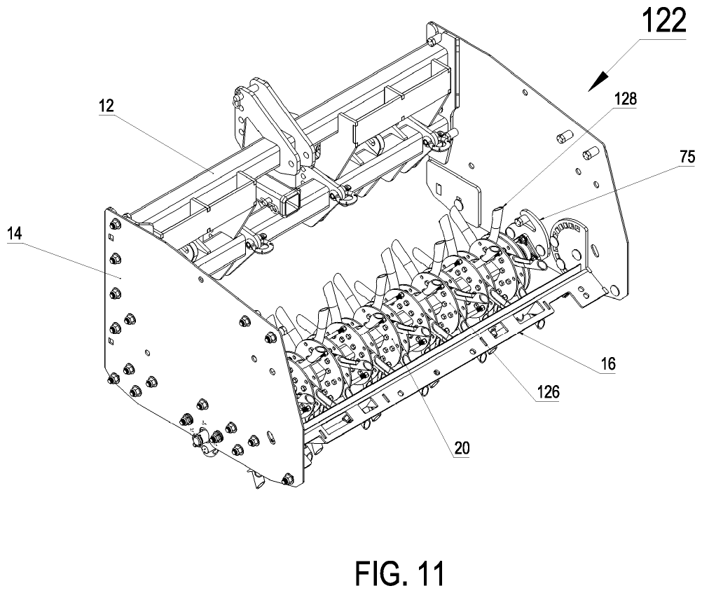

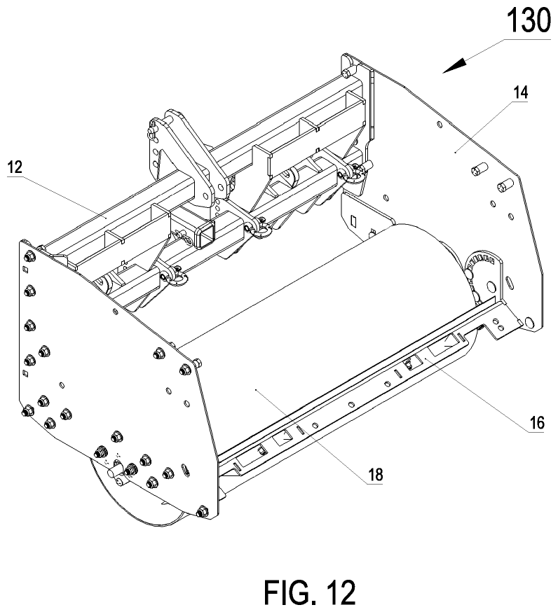

The cutting edge cross member 16 is attachable between opposed side plates 14. The pitch of the cutting edge may be adjustable as best seen in FIGS. 5 and 6. The cutting edge has a cutting edge attachment plate 82 having a perimeter that is generally circular. The cutting edge attachment plate 82 includes a central hole 84 and a plurality of perimeter holes 86 proximate to the perimeter. In use, when the cutting edge cross members 16 are attached to the side plate 14 using the center hole 84, it can be rotated to the desired angle and then fixed at that angle by bolting the attachment plate 82 to the side plate 14 when one of the desired perimeter holes 86 is in registration with one of the holes 72 on the side plate 14. In the embodiment shown herein the cutting edge cross member is adjustable in 15 degree increments. It will be appreciated by those skilled in the art that the angle increments for adjustment may vary depending on the manufacturer. This adjustable feature allows variability in the cutting edge angle and cutting edge depth. It also allows the cutting edge cross member 16 to be rotated out of ground contact if desired. In use, the cutting edge cross member 16 may be part of a configuration with the aerator assembly 20 or the roller 18, as can be seen in FIGS. 11 and 12. The cutting edge cross member 16 includes a detachable cutting edge blade 24. This allows the user to change the blade 24 when needed or to easily remove it and sharpen it. The cutting edge cross member 16 also includes a plurality of front loader adaptor holes 88 so that cutting edge cross member 16 is attachable to the front loader adaptor 26.

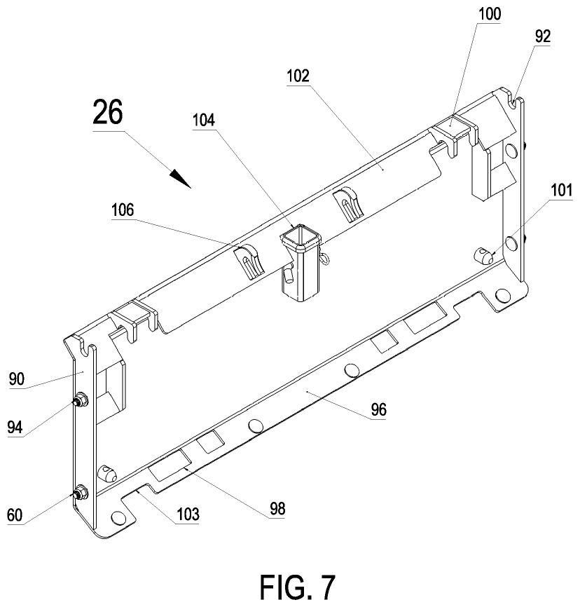

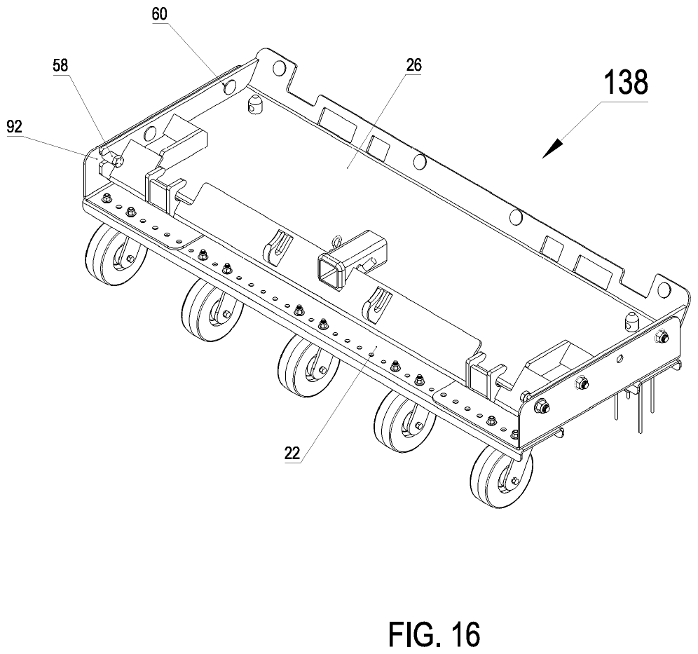

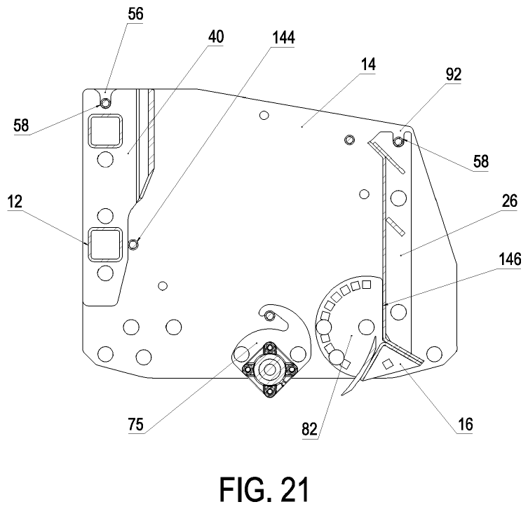

The front loader adaptor 26 as shown in FIG. 7 is constructed to be mounted to a front loader of the tractor. The front loader adaptor 26 is constructed to assists in the assembly and disassembly of the attachments by using the tractor to aid in the process where possible. The front loader adaptor 26 has a pair of front loader adaptor side panels 90. Each front loader adaptor side panels 90 has a groove 92 in the top as shown in the orientation of FIG. 7. Groove 92 is for receiving a locator pin 58, which can also be seen in FIGS. 16 and 21. Each front loader adaptor side panels 90 also has a plurality of holes 94 for receiving bolts when other elements are attached to the front loader adaptor 26. This is similar to the attachment arrangements of the three point hitch frame 12. The front loader adaptor 26 has a bottom lip 96 extending outwardly therefrom. The front loader adaptor 26 includes at least one tractor front loader mount. In the example shown herein the front loader adaptor 26 includes a John Deere™ type mount operably attached thereto and skid steer type mount operably attached thereto. The John Deere™ type mount includes a pair of spaced apart hooks 100 at the top edge of the front loader adaptor 26. The John Deere™ type mount also includes a pair of spaced apart locking pins 101 spaced downwardly from the top edge of the front loader adaptor 26. The skid steer type mount includes an elongate lip or mount 102 extending downwardly along the top of the front loader adaptor 26. The elongate lip or mount 102 may include front loader hooks 106 or a front loader class receiver 104, or both. There is provided a plurality of holes 98 formed in the bottom lip 96. The holes 98 are sized and located to engage with the skid steer mounts of different manufacturers. The front edge of bottom lip 96 is provided with cut outs 103 to ensure the front loader adaptor does not interfere with front loader of the tractor when the front loader adaptor 26 is attached thereto. The skid steer type mount is a mount commonly used in the market and not specific to a brand.

The wear plates 34, the skid shoes 32, the back drag skid shoes 30 and the back drag mouldboard 28 are used to aid in the protection of the edges of the side plates 14 and the front loader adaptor 26 when configured to be used as a mouldboard. They are used as needed depending on the configuration of the attachment being used. These items can be more easily and economically replaced when worn out rather than a whole attachment.

The attachment kit 10 shown in FIG. 1 may be assembled into a variety of different tractor attachments. Examples of the different attachments are shown in FIGS. 8 to 16. FIG. 8 shows the kit 10 assembled as a land plane attachment 110. The land plane attachment 110 includes the hitch frame 12, a pair of side plates 14 attached on either side of the hitch frame 12 and a pair of spaced apart cutting edge cross members 16 attached between the side plates 14. A pair of skid shoes 32 are attached to the respective side plates 14 along the bottom edge thereof. The cutting edge cross member 16 may be angled as needed by the user. The land plane attachment 110 is configured to be dragged behind a tractor.

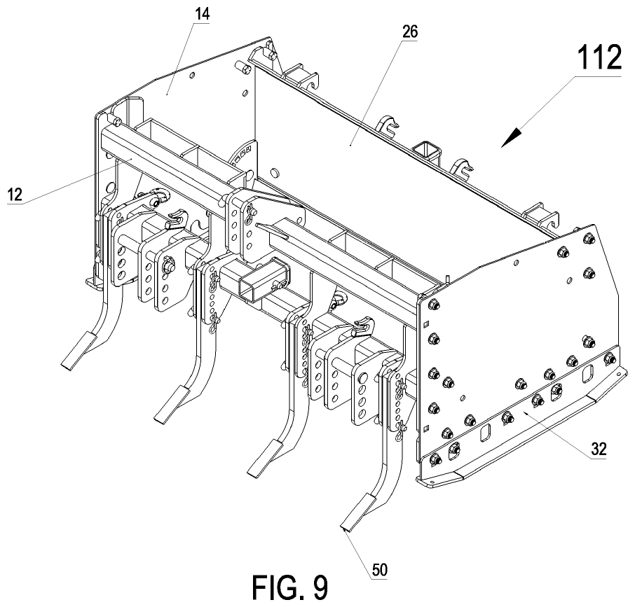

FIG. 9 shows the kit 10 configured as a box blade attachment 112. The box blade attachment 112 includes the hitch frame 12, a pair of side plates 14 attached on either side of the hitch frame 12 and a front loader adaptor 26 attached between the side plates 14. A pair of skid shoes 32 are attached to the respective side plates 14 along the bottom edge thereof. The box blade attachment 112 is configured to be dragged behind a tractor.

FIG. 10 shows the kit configured as a tine rake attachment 114 with the three point hitch frame 12. The front loader adapter 26 has a tine rake assembly 22 mounted thereon and is attached to the three point hitch frame 12 by a receiver adapter 124, which is pinned to front loader adapter class receiver 104 and three point hitch class receiver 70. The tine rake assembly 22 includes a plurality of tines 118 extending downwardly from a tine plate 120. Wheels 116 may be attached to the bottom of the tine plate 120 for applications in which the tine rake attachment 114 is configured to be dragged behind a tractor.

FIG. 11 shows the kit 10 configured as an aerator attachment 122. The aerator attachment 122 includes the hitch frame 12, a pair of side plates 14 attached on either side of the hitch frame 12 and the aerator assembly 20 attached between the side plates 14. A cutting edge cross member 16 is attached between the side plates 14 at the back thereof. The cutting edge is angled so that it does not engage the ground or interfere with the aerator assembly 20. The aerator assembly 20 includes a plurality of spaced aerator blades 126. The aerator blades 126 have a plurality of spikes 128 around the perimeter. The aerator assembly 20 includes a bearing mount assembly 75 at each end thereof. The aerator attachment 122 is configured to be dragged behind a tractor.

FIG. 12 shows the kit 10 configured as a roller attachment 130. The roller attachment 130 includes the hitch frame 12, a pair of side plates 14 attached on either side of the hitch frame 12 and a roller 18 attached between the side plates 14. A cutting edge cross member 16 is attached between the side plates 14 at the back thereof. The cutting edge is angled so that it does not engage the ground or roller 18. The roller 18 is attached to the bearing mount assembly 75 at each end thereof. The roller attachment 130 is configured to be dragged behind a tractor.

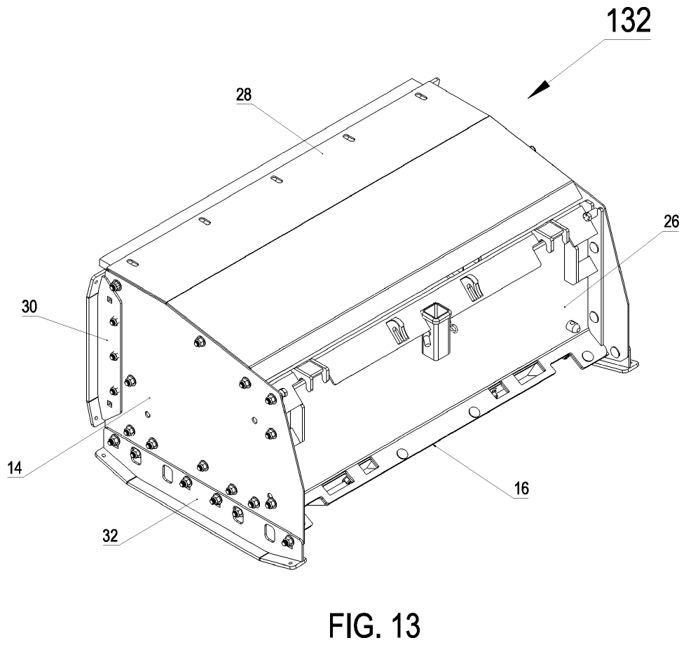

FIG. 13 shows the kit 10 configured as a front loader box plow attachment 132. The front loader box plow attachment 132 is similar to the box blade attachment 112 but the box plow is configured to be attached to the front loader of the tractor. The box plow attachment 132 includes the front loader adaptor 26, a pair of side plates 14 attached on either side of the back drag mouldboard 28 attached between the side plates 14. A pair of skid shoes 32 are attached to the respective side plates 14 along the bottom edge thereof and a pair of back drag skid shoes 30 attached on the sides of the side plates 14. The box plow attachment 132 is configured to be attached to the front of the tractor.

FIG. 14 shows the kit configured as a cultivator attachment 134. The cultivator attachment 134 is the hitch frame 12 with the cultivator tines 50 extending downwardly at the same depth. The cultivator attachment 134 is configured to be dragged behind the tractor.

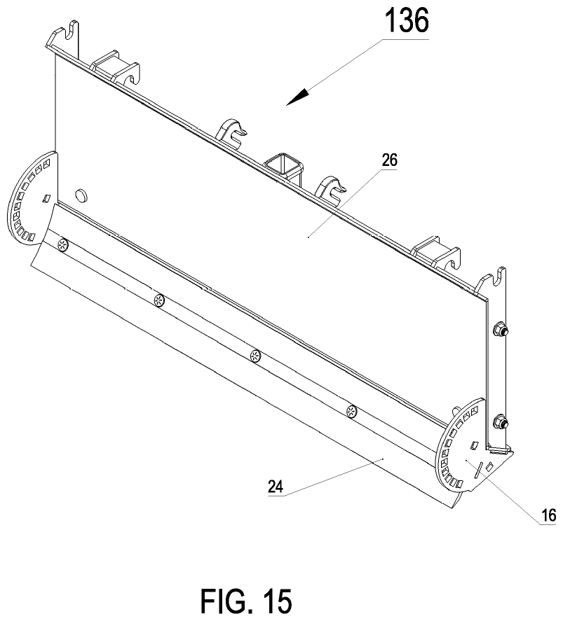

FIG. 15 shows the kit configured as front loader straight plow attachment 136. The front loader plow attachment 136 includes the cutting edge cross members 16 attached to the front loader adaptor 26. The front loader straight plow attachment 136 is configured to be attached to front of the tractor.

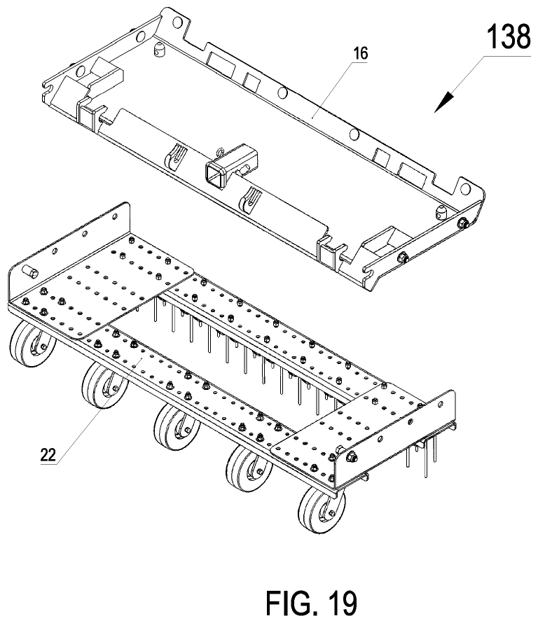

FIG. 16 shows the kit configured as front loader tine rake attachment 138 and FIG. 19 shows a blown apart view of the same. Front loader tine rake attachment 138 includes the tine rake assembly 22 attached to the front loader adaptor 26. The front loader tine rake attachment 138 is configured to be attached to front of the tractor.

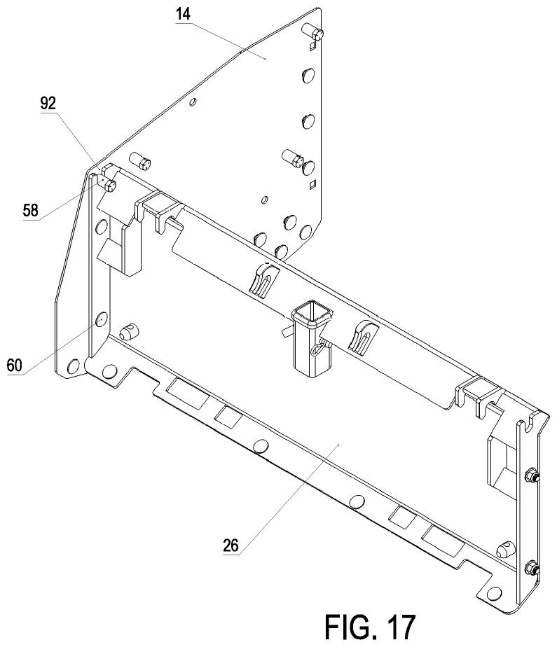

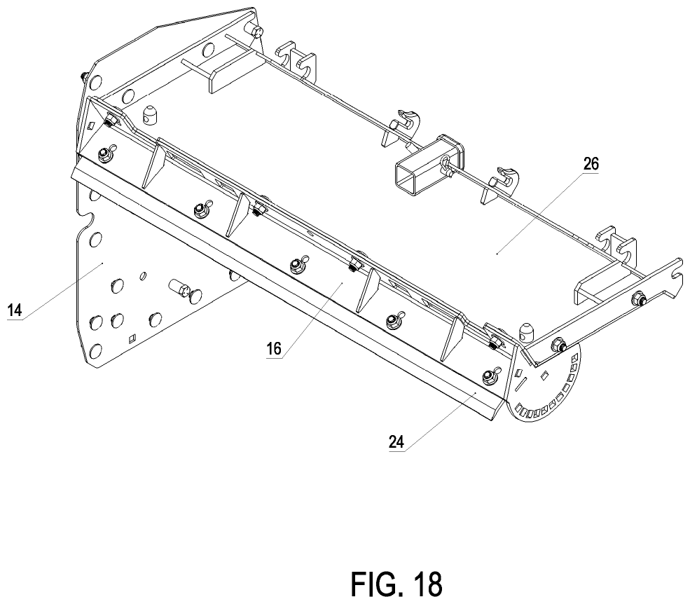

FIGS. 17 and 18 show partially assembled attachments using elements of the kit. In particular FIGS. 17 and 18 show front loader adaptor 26 attached to elements that are not traditionally attached to the front of the tractor. These embodiments illustrate the versatility of the kit shown herein. FIG. 17 shows the side plate 14 attached to the front loader adaptor 26. These may be used in the box blade attachment 112 shown in FIG. 9 or the front loader box plow attachment 132 shown in FIG. 13. FIG. 18 shows the side plate attached to the front loader adaptor 26 and the cutting edge cross member 16 attached to the front loader adaptor 26.

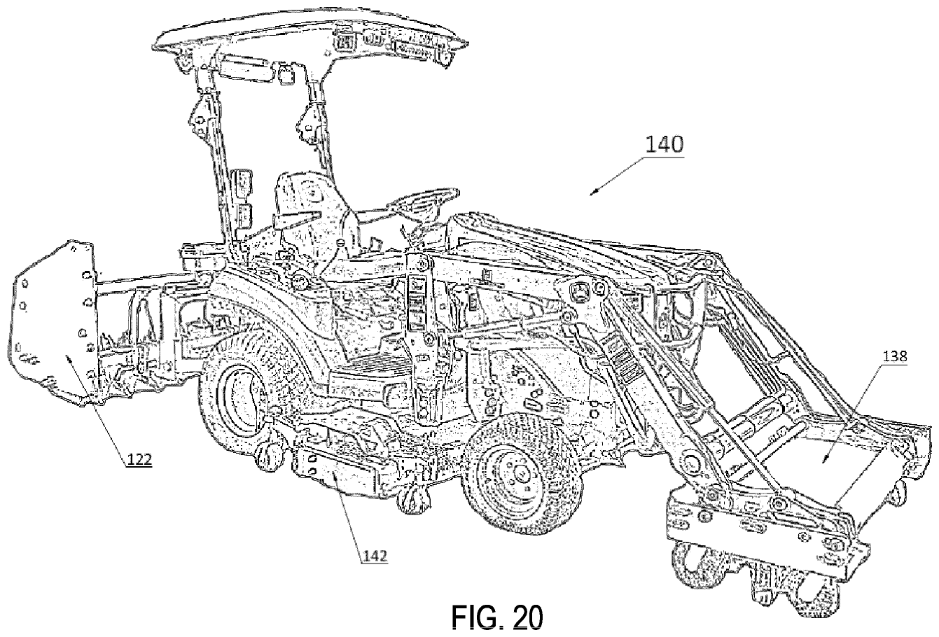

FIG. 20 shows a tractor 140 with the front loader tine rake 138 attached to the front of the tractor 140. The aerator attachment 122 is attached to the back of the tractor 140. The tractor 140 may also include a lawnmower attachment 142 attached under the tractor. It is very clear that the tractor 140 with the attachments as shown in FIG. 20 provides a number of advantages. It allows the user to provide three functions at the same time, tine raking, mowing and aerating. It will be clear that this will save both time and costs by configuring and using the kit 10 on the front or the rear of the tractor 140, or both at the same time with complementary functional configurations.

Optionally, the side plates 14 may have an assisted-alignment pin 144 and assisted-alignment edge 146, as shown in FIG. 21, to assist in the reconfiguration process by providing guides for easy alignment of components such as the hitch frame 12 with the side plates 14. As best seen in FIG. 21, the hitch frame 12 has a groove 56 formed in the top of each side support 40 that may engage with locator pin 58 near the top edge of the side plates 14. When the hitch frame 12 is positioned with the locator pin 58 in the groove 56, the hitch frame 12 can be pivoted about the locator pin 58 until the hitch frame comes into contact with the assisted-alignment pin 144. The assisted-alignment pin 144 is positioned on the side plates 14, so that the hitch frame 12 is thus aligned with the plurality of holes 72 and may be easily fastened in place using a plurality of bolts 60. The locator pin 58 and assisted alignment pin 144 may also be used to assist in aligning various other components with the holes 72 for easy reconfiguration of a wide variety of components. Similarly, the front loader adapter 26 may be installed on side plates 14 using groove 92 formed in the top of each of the side panels 90 and a locator pin 58 and an assisted alignment edge 146 on cutting edge attachment plate 82 of the cutting edge cross member 16, as best seen in FIG. 21.

It will be appreciated by those skilled in the art that the kit shown herein has a wider variety of uses and a wide variety of attachment configurations. The attachment configurations shown herein may be configured to attach to the back of the tractor or configured to attached to the front loader of the tractor. By way of example the configurations may include a land plane attachment, a box blade attachment, a tine rake attachment, an aerator attachment a roller attachment, a front loader box plow attachment, a cultivator attachment, a front loader straight plow attachment, and a front loader tine rake attachment. However, it will be appreciated that there may be other configuration that are also useful.

It will be appreciated by those skilled in the art that the front loader adaptor shown herein has particular advantages and would be useful for any tractor attachments for use with a tractor front loader. Specifically, it would be useful to provide front loader attachments that include a John Deere™ type mount and a skid steer type mount. This would then easily allow the attachment to be used in a fleet that includes both John Deere™ tractors and other tractors.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the scope of this disclosure.

1. A reconfigurable tractor attachment kit for use with a tractor, the kit comprising: a tractor attachment element releasably attachable to the tractor; a pair of side plates releasably attachable to the tractor attachment element on opposed sides thereof; a cross member releasably attachable between the pair of side plates and spaced from the tractor attachment element; and wherein when assembled into an attachment the reconfigurable tractor attachment kit is attachable to the tractor.

2. The reconfigurable tractor attachment kit as claimed in claim 1 wherein the tractor attachment element is a hitch frame attachable to the back of the tractor.

3. The reconfigurable tractor attachment kit as claimed in claim 2 wherein the hitch frame includes a top bar, a bottom bar spaced from the top bar and a pair of side supports attached on opposed sides of the top and bottom bar.

4. The reconfigurable tractor attachment kit as claimed in claim 3 wherein each of a plurality of cultivator tines are releasably attachable to the bottom bar.

5. The reconfigurable tractor attachment kit as claimed in claim 4 wherein each cultivator tine is attachable at different heights and is attachable in an inverted position.

6. The reconfigurable tractor attachment kit as claimed in claim 2 wherein the hitch frame further includes a ballast bracket configured to receive at least one ballast weight.

7. The reconfigurable tractor attachment kit as claimed in claim 2 wherein the hitch frame is a three point hitch.

8. The reconfigurable tractor attachment kit as claimed in claim 2 wherein each of the pair of side plates has a front edge, a back edge, a bottom edge and a top edge and each side plate has a plurality of holes formed therein proximate to the front edge configured to provide different locations for releasably attaching the hitch frame thereto whereby the hitch frame can be configured at different heights and a plurality of holes formed proximate to the back edge and bottom edge for releasably attaching the cross member in different positions.

9. The reconfigurable tractor attachment kit as claimed in claim 8 wherein each of the pair of side plates has a notch formed in the bottom edge and a bushing positioned above the notch, and wherein the notch is configured to receive a shaft of a bearing mount assembly with a hook portion configured to engaged with the bushing when the shaft is positioned in the notch, and wherein one or more fastener apertures on the bearing mount assembly are positioned to align with one or more of the plurality of holes formed proximate to the bottom edge when the shaft is positioned in the notch and the hook is engaged with the bushing.

10. The reconfigurable tractor attachment kit as claimed in claim 8 further including a pair of skids releasably attachable to the bottom edge of each side plate respectively.

11. The reconfigurable tractor attachment kit as claimed in claim 1 wherein the cross member is a roller rotatably attachable between the pair of side plates.

12. The reconfigurable tractor attachment kit as claimed in claim 1 wherein the cross member is an aerator assembly rotatably attachable between the pair of side plates.

13. The reconfigurable tractor attachment kit as claimed in claim 1 wherein the cross member is a first cutting edge cross member.

14. The reconfigurable tractor attachment kit as claimed in claim 13 further including a second cutting edge cross member releasably attachable between the pair of side plates and spaced from the first cutting edge cross member.

15. The reconfigurable tractor attachment kit as claimed in claim 14 wherein the first and second cutting edge cross members are attachable at a plurality of different attach angles.

16. The reconfigurable tractor attachment kit as claimed in claim 1 wherein the cross member is a tine rake assembly.

17. The reconfigurable tractor attachment kit as claimed in claim 1 wherein the tractor has a front loader and further including a front loader adaptor attachable to a tine rake assembly whereby the attached front loader adaptor and tine rake assembly are attachable to the front loader of the tractor.

18. The reconfigurable tractor attachment kit as claimed in claim 1 wherein the tractor attachment element is a front loader adaptor attachable between the pair of side plates.

19. The reconfigurable tractor attachment kit as claimed in claim 18 wherein the tractor has a front loader and the front loader adaptor is attachable to the front loader of the tractor.

20. The reconfigurable tractor attachment kit as claimed in 19 comprising a cutting edge cross member releasably attachable to the front loader adaptor.

21. A tractor attachment for use with a tractor having a front loader comprising: a tine rake assembly releasably attachable to the front loader, the tine rake assembly having a front loader adaptor, a plurality of tines extending downwardly from the front loader adaptor, and at least a pair of spaced apart wheels.

22. The tractor attachment as claimed in claim 21 wherein the tine rake assembly has a plurality of different front loader attachments such that the tractor attachment is attachable to tractors made by different manufacturers.

23. The tractor attachment as claimed in claim 21 further including a second tractor attachment attachable to the back of the tractor thereby configuring the tractor to perform more than one function.

24. The tractor attachment as claimed in claim 23 wherein the second tractor attachment is an aerator assembly thereby configuring the tractor to function as a tine rake and aerator concurrently.

25. The tractor attachment as claimed in claim 23 further including a lawn mower attachment attached under the tractor thereby configuring the tractor to perform three functions concurrently.

26. A tractor attachment for use with a tractor comprising; a hitch frame releasably attachable to the back of the tractor; a pair of side plates attached to the hitch frame on opposed sides thereof; a first and second spaced apart cutting edge rotatably attached between the pair of side plates and spaced from the hitch frame whereby the angle of each cutting edge is adjustable; and wherein when assembled the tractor attachment is dragable behind the tractor.

27. A tractor attachment for use with a tractor having a front loader comprising: a front loader adaptor; a John Deere™ type mount operably attached to the front loader adaptor; and a skid steer type mount operably attached to the front loader adaptor.

28. The tractor attachment as claimed in claim 27 wherein the John Deere™ type mount includes a pair of spaced apart hooks extending from a top edge of the front loader adaptor and a pair of spaced apart locking pins spaced downwardly from the top edge of the front loader adaptor.

29. The tractor attachment as claimed in claim 28 wherein the skid steer type mount includes an elongate lip extending downwardly along a top of the front loader adaptor and a plurality of holes formed in a bottom lip of the front loader adaptor.

30. The tractor attachment as claimed in claim 27 wherein the tractor attachment is one of a front loader box plow, a front loader straight plow, and a front loader tine rake.
